(19) United States
(12) Patent Application Publication
(10) Pub. No.: US 2025/0108448 A1
(43) Pub. Date: Apr. 3, 2025

(54) Methods and System for Multiple Wire Feed Control For Wire-Arc Additive Manufacturing

(71) Applicants: Lincoln Global, Inc., Santa Fe Springs, CA (US); UT-Battelle, LLC, Oak Ridge, TN (US)

(72) Inventors: William G. Carter, Oak Ridge, TN (US); Luke Meyer, Alcoa, TN (US); Christopher J. Masuo, Knoxville, TN (US); Andrzej Nycz, Knoxville, TN (US); Mark Noakes, Knoxville, TN (US); Jason K. Flamm, Chardon, OH (US); Jonathan H. Paul, Knoxville, TN (US); Saket Thapliyal, Knoxville, TN (US)

(21) Appl. No.: 18/897,097

(22) Filed: Sep. 26, 2024

Related U.S. Application Data
(60) Provisional application No. 63/541,350, filed on Sep. 29, 2023.

(51) Int. Cl. B23K 9/12; B23K 9/10; B23K 9/173

(52) U.S. Cl. CPC B23K 9/125; B23K 9/1068; B23K 9/173

(57) ABSTRACT

A welding system for building a workpiece includes a first wire feeder, a second wire feeder, a torch, and a controller. The torch is configured to receive a first wire electrode from the first wire feeder and a second wire electrode from the second wire feeder. The controller is configured to control the first wire feeder to drive the first wire electrode into the torch at a first feed rate, and simultaneously control the second wire feeder to drive the second wire electrode into the torch at a second feed rate.

### CROSS REFERENCE TO RELATED APPLICATION/INCORPORATION BY REFERENCE

This application claims the benefit of U.S. Provisional Application No. 63/541,350 filed on Sep. 29, 2023 entitled “METHODS AND SYSTEM FOR MULTIPLE WIRE FEED CONTROL FOR WIRE-ARC ADDITIVE MANUFACTURING,” the entire contents of which are incorporated herein by reference in its entirety.

### STATEMENT REGARDING FEDERALLY SPONSORED RESEARCH AND DEVELOPMENT

This invention was made with government support under Contract No. DE-AC05-00OR22725 awarded by the United States Department of Energy. This invention was made under CRADA No. NFE-19-07535 between Lincoln Electric Corporation and UT-Battelle, LLC, management and operating contractors for the Oak Ridge National Laboratory for the United States Department of Energy. The government has certain rights in this invention.

### TECHNICAL FIELD

This application relates to additive manufacturing systems, and more particularly, to additive manufacturing for joining different metals.

### BACKGROUND

Various manufactured products may incorporate components with different materials. As may be appreciated, the different materials of the manufactured products may be joined together by fasteners, mating geometries, welding, or other processes. Fasteners or complementary geometries may add components or weight to the joint. Three dimensional additive manufacturing with metals can be useful for creating durable components in a controlled and precise manner. Unfortunately, such processes can be complicated and expensive.

For example, in welding—both manual and robotic—there is often a need to weld different metals together throughout one manufactured piece. The joint between two welded metals can be problematic, especially if the base and weld metals are dissimilar. If two metals have significantly different coefficients of thermal expansion, for example, shrinkage causes different amounts of weld stress between them during the cooling process. This can result in deformations, cracks, and sometimes peeling. It can also lead to low plastic toughness of the welded metal piece. There is a need in the art for improved multi-metallic articles of manufacture and methods for making such articles.

This document describes methods and systems that are directed to addressing the problems described above, and/or other issues.

### SUMMARY

In various scenarios, systems and methods for welding dissimilar metals are disclosed. The systems and methods may be used to create FGMs, alloys, or other parts with sudden transitions and/or without the need to stop the welding process for changing wire electrode. In various embodiments, the systems may include a first wire feeder, a second wire feeder, and a torch configured to configured to receive a first wire electrode from the first wire feeder and a second wire electrode from the second wire feeder. The torch may include a dual wire feeder connector. The system may also include a controller including a processor and a non-transitory computer readable medium comprising one or more programming instructions that, when executed by the processor, will cause the processor to receive one or more parameters for determining a first feed rate of the first wire electrode and a second feed rate of the second wire electrode, and control the first wire feeder to drive the first wire electrode into the torch at the first feed rate and simultaneously control the second wire feeder to drive the second wire electrode into the torch at the second feed rate.

In accordance with an aspect, a welding system for building a workpiece includes a first wire feeder, a second wire feeder, a torch, and a controller. The torch is configured to receive, via a dual wire feeder connector, a first wire electrode from the first wire feeder and a second wire electrode from the second wire feeder. The controller includes logic to receive one or more parameters for determining one or more weld settings. The one or more weld settings include a first feed rate of the first wire electrode and a second feed rate of the second wire electrode. The controller also includes logic to control the first wire feeder to drive the first wire electrode into the torch at the first feed rate and simultaneously control the second wire feeder to drive the second wire electrode into the torch at the second feed rate.

In accordance with another aspect, a method for building a workpiece includes receiving, via a controller, one or more parameters for determining a first feed rate of a first wire electrode and a second feed rate of a second wire electrode. The method also includes controlling a first wire feeder to drive the first wire electrode into a torch via a dual wire feeder connector at the first feed rate, and simultaneously controlling a second wire feeder to drive the second wire electrode into the torch via the dual wire feeder connector at the second feed rate.

### BRIEF DESCRIPTION OF THE DRAWINGS

FIG. 1A schematically illustrates an example system for performing GMAW using at least two wire electrodes and two welders.

FIG. 1B schematically illustrates an example system for performing GMAW using at least two wire electrodes and a single welder.

FIG. 1C schematically illustrates an example system for performing GMAW using at least two wire electrodes and a single welder.

FIG. 1D schematically illustrates another example system for performing GMAW using at least two wire electrodes and a single welder.

FIG. 2A illustrates an example schematic of the wire feeders and torch of the system of FIG. 1.

FIG. 2B illustrates an example dual wire feeder connector.

FIG. 2C illustrates a cross-sectional view of the dual wire feeder connector of FIG. 2B.

FIG. 3 illustrates a flow chart of an example method of performing an additive manufacturing process.

FIG. 4 is a block diagram that illustrates various elements of a possible electronic system, subsystem, controller and/or other component of the system of FIG. 1, and/or external electronic device.

### DETAILED DESCRIPTION

As used in this document, the singular forms “a,” “an,” and “the” are intended to mean one or more unless context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

Functionally graded metal deposits may be used to join two different metals. A Functionally Graded Material (FGM) refers to a composite material having a progressive compositional gradient changing from one side to the other of a layer. An alloy gradient can serve to make the transition between two metals less abrupt, increasing cohesion between adjacent sections of a piece and in turn increasing its overall strength and toughness. Additive manufacturing may be used for manufacturing FGMs. Additive manufacturing produces structures layer by layer, and it is possible to change the compositions of materials in each layer to create FGMs. However, traditional additive manufacturing uses only one type of material at a time. The current disclosure describes systems and methods to create FGMs using additive manufacturing by dynamically changing the ratio of two or more metals. Specifically, the current disclosure describes gas metal arc welding (GMAW) systems having a plurality of individually selectable and separately controlled simultaneous wire feeds in a single torch.

GMAW is a method of welding metal workpieces in industrial application, and typically includes a torch (or welding gun), a nozzle, a power supply, a wire feed unit configured to feed a wire electrode (e.g., a welding consumable) to the torch, and a shielding gas supply/network. The power supply generally supplies power for the GMAW system and/or other various accessories and may be coupled to the wire feed unit via one or more weld cables, as well as coupled to a work piece. The torch includes a conductive contact tip that is axially aligned inside the nozzle and configured to transmit electrical energy to the wire electrode as it passes through the contact tip (e.g., by contacting the wire). The applied voltage between the charged wire and workpiece produces an intermediate electric arc. The heat energy generated by the arc fuses the wire in a globular, short-circuiting, or spray mode and penetrates the workpieces to form the weld.

Welding two dissimilar metals using a single torch in a GMAW system presents numerous challenges. A significant difference in the melting points of the metals can lead to difficulty in creating an alloy with a single heated arc because the metal with the lower melting point can evaporate and lead to excessive defect formation. For two highly dissimilar metals like iron and lead, the molten iron is insoluble in the weld pool of molten lead and thereby not conducive to the creation of an alloy. Welding two metals with different electromagnetic properties can also be problematic as they destabilize the welding arc. Particularly oxidizable metals such as copper and aluminum can lead to oxides in the molten pool, which in turn leads to weaker bonding during the cooling crystallization process. Dissimilar non-ferrous metals present strength disparity issues at the point of fusion as well. Additionally, there are specific concerns anticipated for this type of application. For example, because two different wires will be used with a single arc there is a concern that the arc will be unstable, which may undesirably cause the wire to fuse to the contact tip. Moreover, if the arc is unstable and wanders it could lead to an unstable weld bead. The current disclosure describes systems and methods for overcoming the above challenges.

The present disclosure presents system and methods for joining dissimilar metals or producing a FGM by configuring and dynamically controlling the feed rates of different metal wire electrodes into a welding arc (in real time). The wire feeder speed rates are individually and dynamically controlled to manipulate the ratios of the metal alloys deposited throughout a print or weld process to obtain the FGM and/or alloys including dissimilar metals.

In accordance with an embodiment, the current disclosure describes systems and methods for feeding multiple wire electrodes through a single torch simultaneously, each with their own wire feeder, in order to create differing alloys having gradual material transitions that form a gradient as opposed to a sudden interface. In some embodiments, this also allows multi-material parts to be created without the need to stop the weld to change wire electrode materials, thereby reducing the number of wire changeouts required to build a part. By changing the feed-rate of the different wire electrodes in real-time, the deposited alloy can be changed on the fly without stopping the welding process to change wire electrodes or torches. Additionally, this allows for the creation of alloys that might not be available in wire electrode form by combining wire electrodes of two different materials in the same weld. Prior art wire arc additive manufacturing systems are not equipped with such on-the-fly alloying capabilities that are required for facilitating high-throughput alloy discovery. For example, through the various examples of alloying enabled by this disclosure, alloys with different compositions can be deposited rapidly. The subsequent microstructural and/or mechanical characterization can reveal the composition that leads to the required microstructure for the intended application. By combining wires of different materials (two or more) in the same weld, this technology also allows for the deposition of novel alloys or alloys that are currently unavailable in wire form.

In another example application, simultaneous feeding of multiple (two or more) different wire electrodes into the weld pool allows the system to produce distinct alloys from a static ratio of the wires (e.g., X % of wire 1, Y % of wire 2) without dynamically controlling their feed rates. As an example, if an application requires an alloy comprising 73% Cu/23% Ni (not a standard alloy), it can be manufactured using the principles of this disclosure by feeding a Cu wire electrode and a Ni wire electrode at different rates (at a ratio of 73:23) to achieve this alloy composition of the desired ratio. A part could be built using this alloy with no functional grading or dynamic control/adjustment of the material feed rates.

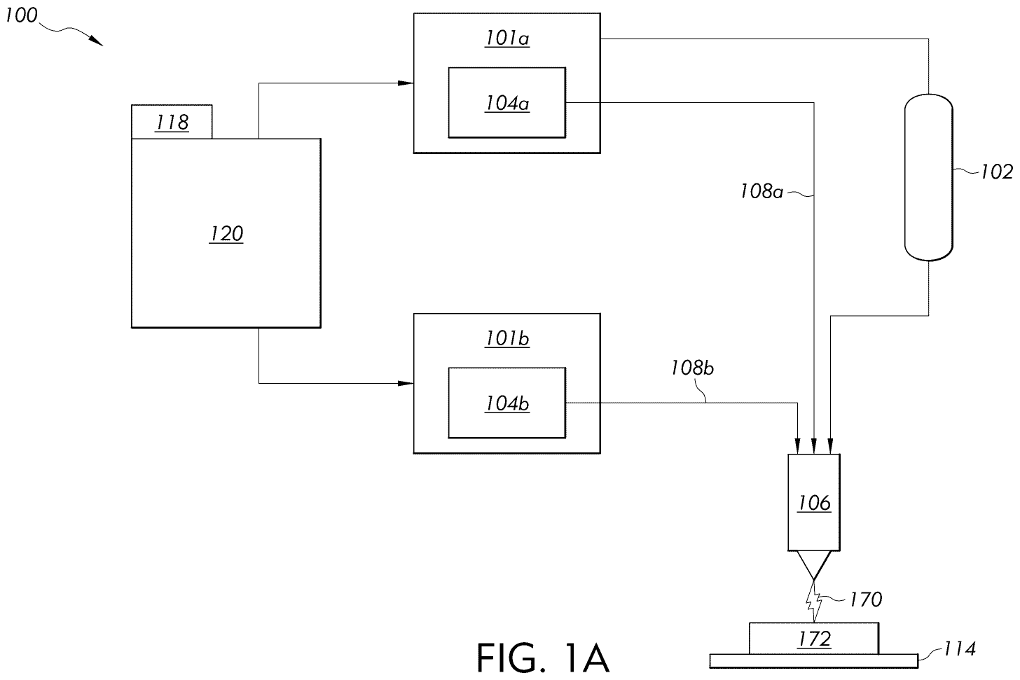

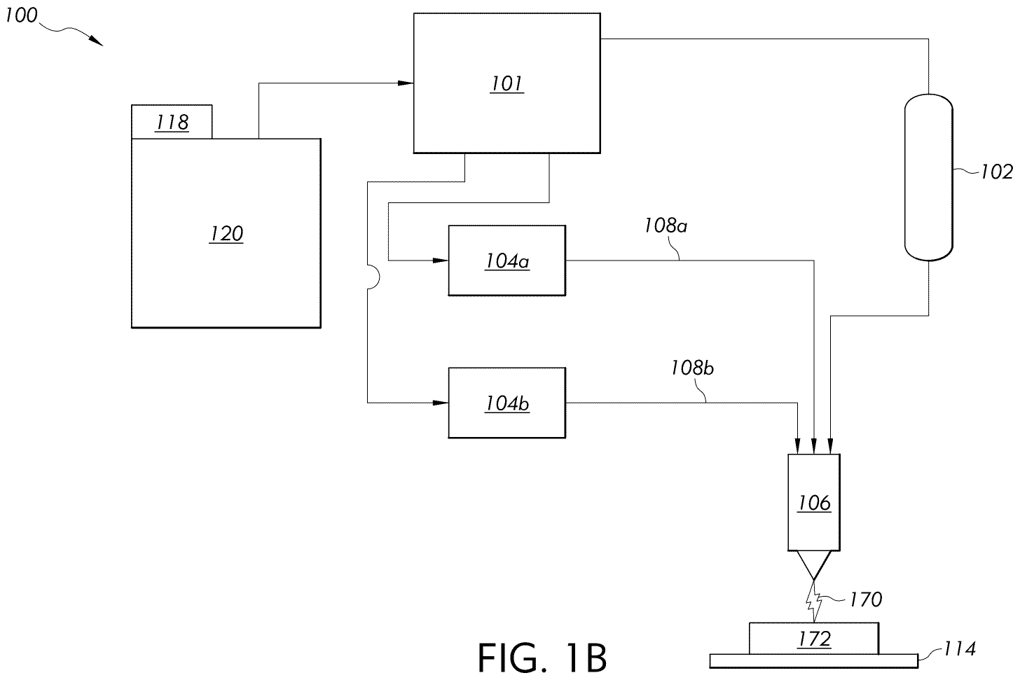

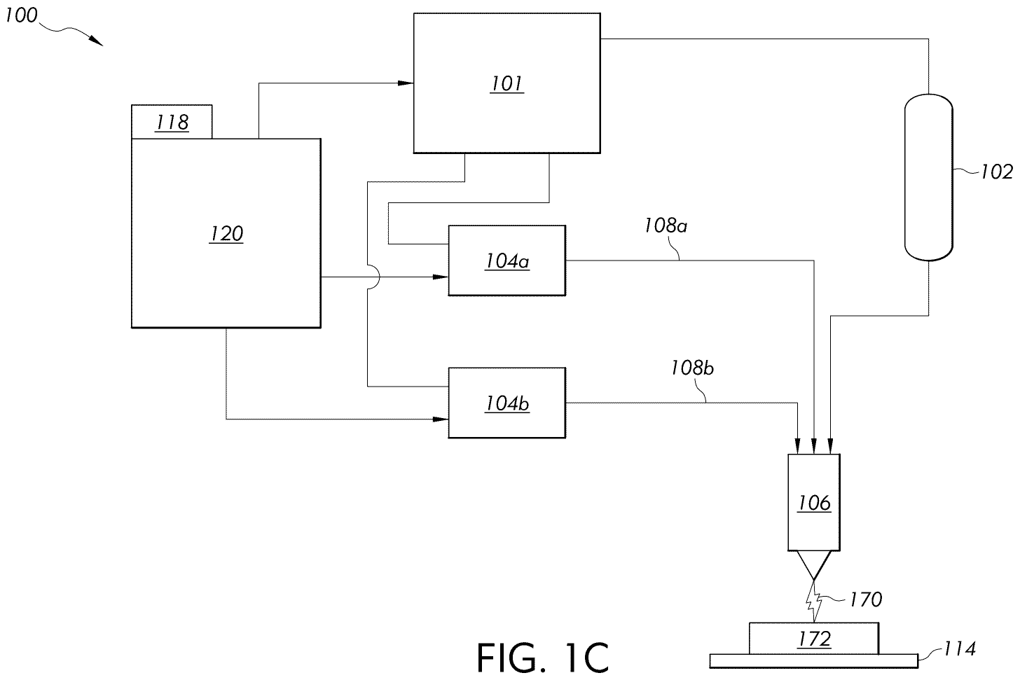

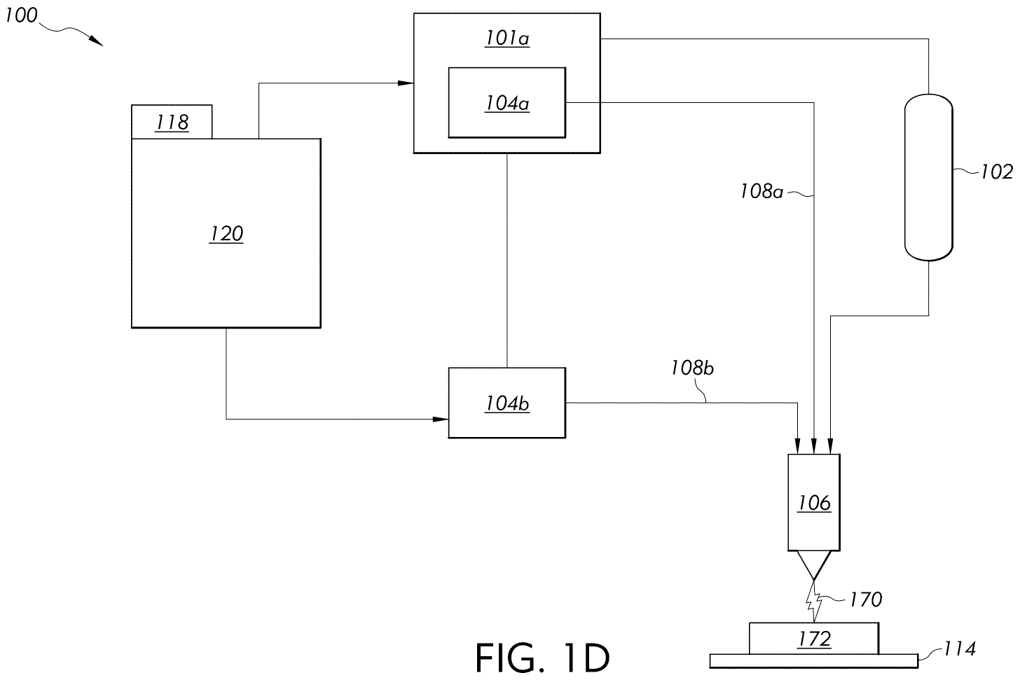

FIG. 1A illustrates an example system for additive manufacturing using two separately controlled wire feeders, in accordance with this disclosure. As shown in FIG. 1A, the system 100 includes a first welder 101(a) and a second welder 101(b). The first and second welders 101(a) and 101(b) may embody welding power sources configured to convert input power (e.g., from an external utility power source) to a controlled welding output (e.g., a constant voltage or constant current output). For example, the first and second welders 101(a) and 101(b) may embody GMAW welding power sources, each configured to produce a constant output voltage while the output current thereof is varied (e.g., via wire feed speed). In some embodiments, the first and second welders 101(a) and 101(b) may embody gas tungsten arc welding (GTAW) power sources (e.g., for automated or semi-automated TIG welding), each configured to maintain a constant output current while the output voltage thereof is varied based on arc length (e.g., between a workpiece and tungsten electrode). In some embodiments, the first and second welders 101(a) and 101(b) may embody multi-process welding power sources, each configured to provide constant voltage or constant current based on the particular type of welding application required (e.g., GMAW, submerged arc welding (SAW), or GTAW). In the embodiment shown, each of the welders 101(a) and 101(b) is in communication with a system controller 120. The controller 120 may be a separate element communicatively coupled with the first and second welders 101(a) and 101(b). It is contemplated that each welder may comprise a respective controller that is communicatively coupled with a remote system controller and/or a remote server. The system controller 120 may be configured to provide control signals to the welders 101(a) and 101(b), wire feeders 104(a) and 104(b), a welding torch 106, and/or other components of the system 100. Each of the welders 101(a) and 101(b) may include (and/or be communicatively coupled with) a separately and individually controlled wire feeder 104(a) and 104(b) for supplying wire electrodes 108(a) and 108(b) (e.g., solid wire, cored wire, coated wire) to the torch 106, for example, via cable assemblies therebetween. One or both of the welding power sources 101(a) and 101(b) may be configured to supply power to the torch, for example, via independent cable(s) comprising conductive strands or elements, or via welding cable assemblies configured to supply wire electrodes to the torch. The controller 120 may be configured to provide control signals to the welders (e.g., 101(a), 101(b)) and/or to the wire feeders (e.g., 104(a) or 104(b) for controlling the additive welding process. The control signals may comprise weld settings, including, but not limited to, a weld current, wire feed speed (e.g., for each wire electrode), voltage, power, welding process type (e.g., GMAW, GTAW, SAW, FCAW, etc.), polarity, trim, welding joint configuration, welding gun setting, shielding gas composition, shielding gas flow rate, a cycle time, a duty cycle, and the like. Each wire feeder 104(a) or 104(b) may be configured to receive the control signals to independently control the feed rate of the respective wire electrode 108(a) or 108(b) supplied to the welding torch 106. Any number of controllers are within the scope of this disclosure. A welder may include one or more automated devices (e.g., robotic arms). The controller may determine the control signals based on parameters it receives relating to the additive welding process, including, but not limited to, parameters such as the desired composition of weld piece, the desired mechanical properties, the desired weld pool joint characteristics, a desired final amount of wire electrode supplied through each feeder, a desired alloy (defining the constituent proportions thereof), a desired composition of the resulting weld at various stages or periods of the welding process, a desired composition of the weld at various layers of the weld piece, and the like.

It should be noted that while FIG. 1A illustrates a first welder 101(a) and a second welder 101(b) each including wire feeders 104(a) and 104(b), the disclosure is not so limiting. Essentially, the controller is configured to dynamically control and change feed rates of individual electrodes (directly and/or indirectly via the welder and/or wire feeders) while allowing a single torch to be connected to multiple wire feeders. For example, FIG. 1B illustrates a single welder 101 that is in communication with a controller 120. In some embodiments, the welder 101 may include the controller 120. The single welder or controller may be configured to provide separate control signals to the wire feeders 104(a) and 104(b). In the embodiment of FIG. 1B, the welder 101 also provides weld current to the welding torch 106. The weld current may be provided to the welding torch 106 via a power cable extending between the welder 101 and the torch 106. It is also contemplated that weld current may be provided to the torch 106 via one or both of the cable assemblies connecting the first and second wire feeders 104(a) and 104(b) to the welding torch 106. In another embodiment shown in FIG. 1C, a controller 120 may be directly communicatively coupled with wire feeders 104(a) and 104(b) in order to provide separate control signals to the wire feeders 104(a) and 104(b). The controller 120 may also provide control signals to the welder 101 for controlling the torch 106.

In yet another embodiment shown in FIG. 1D, system controller 120 sends control signals related to weld settings, for example, weld current level(s) and/or wire feed settings to a single welder 101. The welder 101 may send weld current to the torch 106 (e.g., via a cable assembly extending between the welder 101 and the torch). In this embodiment, the controller also sends a control signal (comprising wire feed settings) to wire feeder 104(a). The remaining wire feeders (e.g., 104(b)) may be controlled independently by the system controller 120. In the embodiment shown wire feeder 104(b) is operatively connected to welder 101(a) to receive power therefrom (to power the wire feeder). In some embodiments, the wire feeder(s) may receive power another power supply source, e.g., other than from the welder.

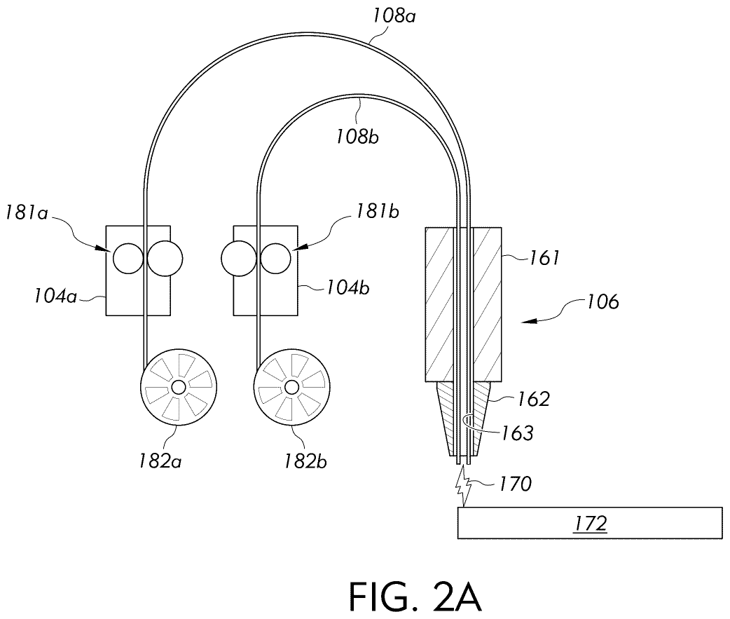

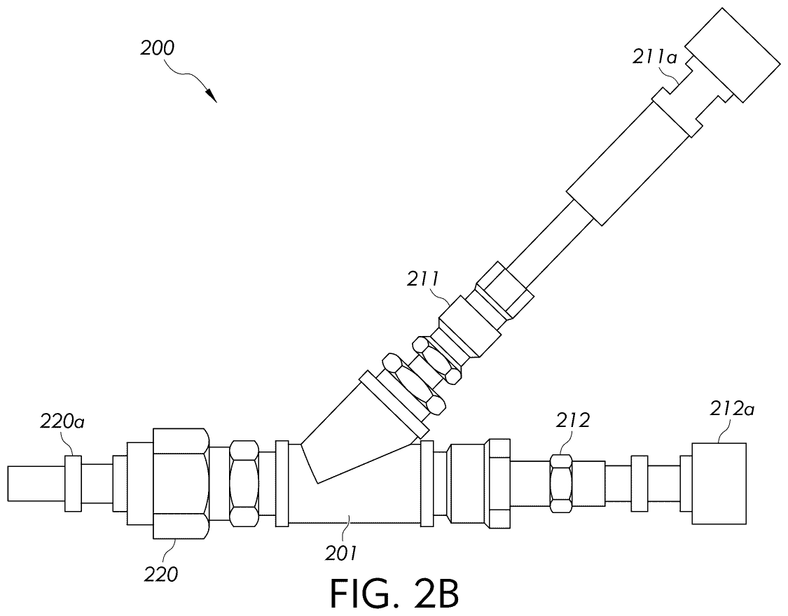

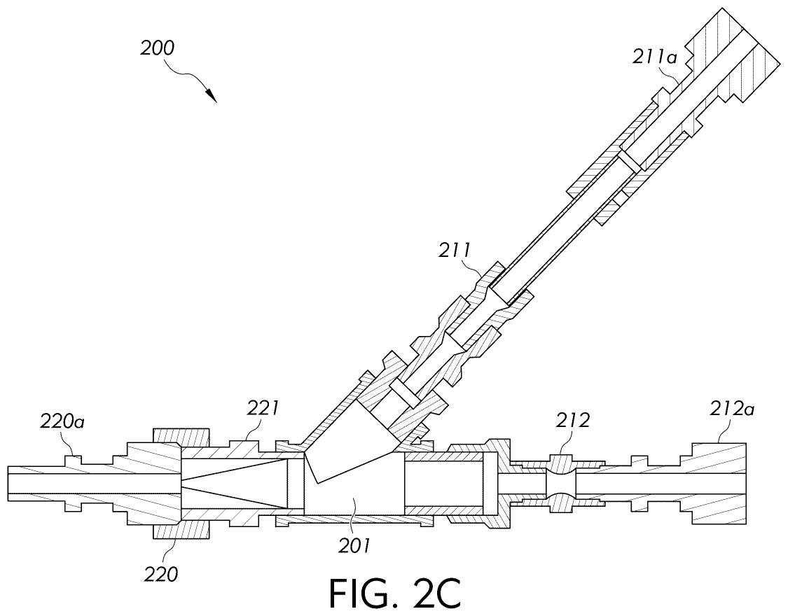

FIG. 2A illustrates a schematic representation of the torch 106 comprising a nozzle 161 and a contact tip 162 defining an orifice 163. Specifically, the contact tip 162 is shown having two wire electrodes 108(a) and 108(b) passing through the orifice 163. It is contemplated that the contact tip 162 may define more than one orifice, for example, two or more orifices dimensioned to supply two or more respective wire electrodes therethrough. It is also contemplated that the torch 106 may include two or more contact tips, each defining a respective orifice for a respective wire electrode supplied therethrough. In such embodiments, it is contemplated that each contact tip may be energized by a respective power source or wire feeder (e.g., via a respective power cable extending between the torch and the power source or wire feeder) to effect different output current values. In various embodiments, the diameter (and other dimensions) of components of the nozzle and the contact tip may be configured to provide a desired welding current via the two wire electrodes, without causing damage to the components (e.g., by overheating). It is to be appreciated that each of the wire electrodes can be continuously fed, periodically fed, or fed based on a predetermined order (discussed in more detail below), while the feed rates thereof are individually and dynamically controlled by the system controller 120. As in singular wire feeds, the contact tip 162 may function to transmit current to the wire electrode(s) fed therethrough, while the wire electrode(s) are continually directed into an arc zone 170 between distal ends of the wire electrode(s) and the workpiece 172. Optionally, the contact tip 162 converges the wire feeds of the wire electrodes towards a point within the arc zone 170, so as to promote wire material diffusion/intermixing and increase arc heat flux density.

As shown in FIG. 2A, the system is configured to introduce the wire electrodes at feed rates that are selectively and individually controllable, so as to be separately adjusted. To that end, the system further includes at least one independently operable advancing mechanism 181(a) and 181(b) (e.g., comprising a pair of counter-rotating drive rolls in the embodiment shown) configured to pull or otherwise move the wire electrodes 108(a) and 108(b) therethrough and into respective cable assemblies (e.g., comprising liners) for conveying the electrodes 108(a) and 108(b) to the torch 106 In some embodiments, the advancing mechanisms 181(a) and 181(b) may form part of the first and second wire feeders 104(a) and 104(b). Rotatable wire reels 182 (a) and 182 (b) may be provided to store the wire electrodes, such that the wire electrodes may be unwound when the actuating mechanism(s) pull the wire electrodes therefrom, i.e., to supply the wire electrodes 108(a) and 108(b)) to the respective advancing mechanism. For example, the advancing mechanisms 181(a) and 181(b) can include respective stacked roller pairs that are cooperatively sized (e.g., via dimensioned grooves) and configured to grip (via friction) and advance the wire electrodes at a desired feed rate. Other examples of advancing mechanisms may include belts, friction driven mechanisms, or the like.

Variability of feed rate may be provided, for example, by altering the power input to the advancing mechanisms 181(a) and 181(b), as is known in the art. For example, a plurality of potentiometers may be used to effect variable motor output from a power source.

The system controller 120 (e.g., FIGS. 1A-1D) may be configured to autonomously actuate each of the advancing mechanisms 181(a) and 181(b) separately, modify their respective feed rates, and actuate the torch 106 after confirming proper wire feeding. The controller may also be configured to receive sensory input (e.g., from one or more appropriately positioned sensors operable to detect the actual motion of a wire, arc zone characteristics, current, voltage, etc.), and cause the feed rates to be adjusted based on the sensory input.

In the examples of FIGS. 1A-1D, each of the wire feeders 104(a) and 104(b) supply a wire electrode 108(a) and 108(b) (e.g., solid wire, cored wire, coated wire) to the torch 106. The wire electrodes 108(a) and 108(b) may be made from dissimilar metals. It should be noted that while FIGS. 1A-1D illustrate two wire feeders supplying respective wire electrodes, the disclosure is not so limiting, and any suitable number of wire feeders and wire electrodes may be provided (e.g., 3, 4, 5, or the like) and controlled in accordance with this disclosure. The wire electrode(s) may have a substantially circular cross-section, but in other embodiments the wire electrode(s) may have a cross-section that is substantially rectangular, square, or ovular. The diameter (or other lateral cross-sectional dimension) of the metal wire(s) may be chosen based on the desired properties of deposition.

In some embodiments, each wire electrode may include a different metal composition, so as to provide increased flexibility and for enabling a variety of applications. For the purposes of this disclosure, the term “different metal composition” shall encompass functionally non-equivalent material constituencies in the context of GMAW (such as, without limitation, differing tensile strengths, differing fluidity, differing viscosity when molten, differing compositions (e.g., different metals or alloys), and/or the like). The wire compositions may be selected so as to provide an operator with differing alternatives and the ability to change the mechanical properties of the weld joint.

In operation, the controller may receive information (e.g., parameters) regarding the application (e.g., workpiece thickness, mechanical properties, stack configuration, and composition, etc.) from a user, and use the received information to determine a desired total wire amount (in the resulting alloy or workpiece) for each of the wire electrodes. The controller is configured to then determine, in real-time, a feed rate for each of the wire electrode feeds that would yield the desired amount. For example, if the resultant workpiece is desired to have a ratio of 1:3 of two different metals, the speeds of the corresponding wire electrodes may be controlled at the same ratio (i.e., 1:3 by, for example, feeding the respective wires at 100 and 300 inches per minute when the wires are of the same thickness or dimensions). Optionally, a look up table or other database may be provided that includes the amount of a wire electrode and corresponding feed rates for a given set of wire feeds and applications.

Additionally and/or alternatively, the controller may determine resultant weld pool and joint characteristics based upon the material properties of the wire feeds and/or may optimize (i.e., determine the preferred rates for), in real-time, the feed rates in order to achieve that pool or joint characteristic. Once the feed rates are determined, the controller may actuate the torch and advance the wire feeds into the arc zone 170 at the feed rates by sending the appropriate signal to the corresponding drive mechanisms. In various embodiments, the controller may also be configured to determine a total wire contribution for each of a plurality of asynchronous application periods (or phases) of the GMAW process, and to achieve these contributions by determining separate feed rates for each of the wire feeds during that period. For example, an arc initiation contribution may be determined and produced over a first period, such that spatter is minimized and heat energy is reduced; and a main joint fill contribution may be determined and produced over a second period, so as to control weld pool shape and result in the desired joint strength. Finally, a crater fill contribution may be determined and produced over a third period.

FIGS. 2B and 2C illustrate a modified dual wire feeder connector 200 configured for feeding separately controlled wire electrodes to a front end of a torch, for example, through the nozzle (e.g., a nozzle 161). FIG. 2C illustrates a cross-sectional view of the dual wire feeder connector 200 of FIG. 2B. The dual wire feeder connector 200 comprises a Y-fitting 201 coupled to distal ends of arms 211 and 212 and to the proximal end of a stem 220. For example, the Y-fitting 201 may include threads, friction fit connectors, interference fit connectors, quick disconnect connectors or any other suitable type of coupling mechanisms for coupling the Y-fitting to the arms 211 and 212, and to the stem 220. Suitable connectors 211(a) and 212 (a) may be provided at the proximal ends of the arms 211 and 221 and configured to couple to the wire feeders 104(a) and 104(b) respectively (e.g., threads, friction fit connectors, interference fit connectors, quick disconnect connectors or any other suitable type of coupling mechanisms). In some embodiments, the proximal ends of the arms 211 and 221 may be configured and dimensioned to connect to distal ends of flexible cable assemblies connected to the wire feeders 104(a) and 104(b), e.g., cable assemblies each comprising a liner for conveying a respective wire electrode therethrough. The arms 211 and 212 provide channels for receiving the wire feeds from the respective wire feeders and direct them into a channel of the stem 220 via the Y-fitting 201 without causing wire entanglement or other interferences. For this purpose, the channels may comprise a smooth wall (to reduce friction or entanglement), or lined with a rigid, low-friction material, for example a flexible tube (e.g., a plastic liner, coiled steel liner, or a liner made from a helically wound wire) to provide a conduit for the wire electrodes to pass through. The stem 220 may include a funnel 221 configured for guiding all the wires into a single channel connected to an orifice of the contact tip. The funnel 221 may include an inclined wall (as shown) to facilitate guiding the wires into the single channel. It is also contemplated that there may be more than one funnel, for example, to guide two or more wire electrodes into separate channels, leading to respective orifices of the contact tip. The proximal end 220 (a) of the stem 220 may include a suitable connector for coupling to a torch (e.g., torch 106).

The material(s) for forming the dual wire feeder connector may be configured to prevent damage to the connector (e.g., based on exposure to electrical current(s) transmitted to the electrode wires) and for minimizing resistance to the current (e.g., brass, copper, steel, etc.). Each of the components of the dual wire feeder connector 200 may be configured to provide a desired welding current into the two electrodes. For example, the components (when made from brass) may be configured to have a diameter of at least about 0.160 sq. inches to about 0.170 sq. inches, about 0.162 sq. inches to about 0.168 sq. inches, 0.164 sq. inches to about 0.166 sq. inches, or the like. Other suitable component diameters are within the scope of this disclosure. The length of the dual wire feeder connector 200 may be configured to effectively dissipate heat generation because of the weld current to avoid damage to the dual wire feeder connector (e.g., due to melting). For example, the length of the dual wire feeder connector (when made from brass) may be at least about 11 inches to about 14 inches, about 12 inches to about 13 inches, or the like.

Referring back to FIG. 1A, the first welder 101(a) may include and/or may be coupled to a gas supply 102 that may supply a shielding gas and/or shielding gas mixtures to the welding torch 106. A shielding gas, as used herein, may refer to any suitable gas or mixture of gases (including, but not limited to, Argon, Carbon Dioxide, Helium or any suitable mixture thereof) for a specific welding application that may be provided to shield the arc and/or weld pool from contaminants in the environment (e.g., Nitrogen, Hydrogen, or Oxygen) that could adversely impact arc stability, enable the formation of metal oxides or porosity, preclude wetting of the weld puddle, alter the chemistry of the weld deposit, and so forth). While FIGS. 1A-1D illustrate the gas supply 102 being coupled directly to the welding torch 106 (and interconnecting the torch and the welder), in some examples, the gas supply 102 may be coupled to the welding torch 106 through the wire feeder 104(a) via, for example, a gas conduit disposed in the welding torch cable assembly extending between the wire feeder and the welding torch. In such an example, the wire feeder(s) and/or power sources may be configured to regulate the flow of gas from the gas supply to the welding torch. In some examples, the controller may be operatively connected to a regulator/flowmeter to control the flow rate. In other examples, the gas supply may comprise a regulator/flowmeter operable to control the flow rate. In some embodiments, the gas supply may be coupled to the welder, and the welder may then supply gas to the torch (e.g., via a cable assembly extending between the welder and the torch).

The gas supply 102, may be integral or separate from welder (101(a), 101(b), 101). In some examples, no gas supply may be used, for example, when welding with a wire electrode comprising a flux coating configured to shield the arc and/or weld pool from contaminants in the environment. The welder (101(a), 101(b), 101) may supply power to the wire feeder 104(a) (e.g., via a control cable) that, in turn, supplies power to the welding torch 106 (e.g., via a cable assembly therebetween), in accordance with the control instructions provided to the welder (101(a), 101(b), 101). It is also contemplated that at least one of the welders (101(a), 101(b), 101) may supply power to the welding torch via a power cable assembly (e.g., independent from the cable assemblies connecting the wire feeders to the torch for conveying wire thereto). In this manner, it should be understood that a wide variety of configurations are contemplated and within the scope of the present disclosure. At least one of the welders (101(a), 101(b), or 101) may be coupled to the work piece 172 (e.g., via a work lead) to close the circuit between the welder (101(a), 101(b), 101), the work piece 172, and the welding torch 106. Optionally, the welder (101(a), 101(b), 101) may include circuitry that receives input power from an external utility means, for example, the AC power grid, an engine/generator set, or a combination thereof). The welder (101(a), 101(b), 101) may condition the input power, and provide DC and/or AC welding-type output power to the torch or other components of the system, e.g., for example, to provide power to a wire feeder and to the torch. As is known in the art, the torch 106 functions to produce an electric arc 170 and associative heat zone (not shown here) having a minimum operating temperature sufficient to melt the base material of a workpiece, wherein the specifications of welding (e.g., operating temperature, travel speed, voltage, etc.) are dependent upon workpiece/wire electrode size and composition.

A platform 114 may support the work piece 172 and may be configured to be moved in one or more of five or six axes of control (e.g., one or more of the XYZ planes) via one or more actuators (e.g., motors such as stepper motors). Similarly, a gantry (not shown here) may support the torch and is capable of motion in one or more of five or six axes of control (e.g., one or more of the XYZ planes) via one or more actuators (e.g., motors such as stepper motors).

In various embodiments, the system may also include a user interface 118 (e.g., a user interface provided on the controller 120 (as shown), on the welder (101(a), 101(b), 101—such as on the welder housing), or on the wire feeder (104(a), 104(b)). In some examples, the system 100 may receive weld settings from a user via the user interface 118. The weld settings may relate to the weld power, voltage, current level (e.g., wire feed speeds for the respective wire feeders), or any other example of a weld setting disclosed herein. In some embodiments, the user interface 118 may be operable to receive parameters, for example, the desired composition of the weld piece (or other examples of parameters for determining the wire feed rates as discussed above).

Optionally, the user interface 118 may be coupled to the controller 120 housing and operable to communicate the parameters to the controller, for example, parameters such as the desired composition of weld piece, the desired mechanical properties, the desired weld pool joint characteristics, a desired final amount of wire electrode supplied through each feeder, a desired alloy (defining the constituent proportions thereof), a desired composition of the resulting weld at various stages or periods of the welding process, and the like. The user interface may also be operable to receive desired parameters, and communicate the parameters to the controller 120, wherein the controller then determines control signals (e.g., weld settings) based on the parameters. In some examples, the controller 120 may control the welder (101(a), 101(b), 101) to produce an appropriate and/or desired current (e.g., wire feed speed) and/or voltage (e.g., corresponding to a weld transfer mode (e.g., short circuit, spray arc, etc.) supplied to the torch 106, as selected, for example, by an operator through the user interface 118. The controller 120 may also monitor the current and/or voltage of the arc 170 (in real time) using one or more suitably disposed sensors (e.g., within, along, and/or proximate to the wire feeder, welder, and/or torch). The one or more sensors may comprise, for example, current sensors, voltage sensors, impedance sensors, temperature sensors, acoustic sensors, and/or other appropriate sensors. In some examples, the controller 120 may determine and/or control the welder to produce an appropriate power output, arc length, and/or electrode extension based at least in part on feedback from the sensors. For example, the controller can utilize settings such as wire size, wire type and wire feed speed to determine a voltage to be maintained during the process. During operation the output heating signal is maintained such that the average voltage of the output signal, over a predetermined duration of time or number of cycles, is maintained at the determined voltage level.

The controller 120 may also control the wire feed speed for wire feeders 104(a) and 104(b) as discussed above based on the desired composition of the weld piece, other user input, and or sensor information. Weld wire feed speed may also be used by the controller to set other operating parameters such as voltage, current, arc length, duty cycle, and the like. Moreover, by calibrating voltage, current, arc length, duty cycle and other parameters based on the determined wire feed speed, these other parameters are set to values consistent with the determined wire feed speed.

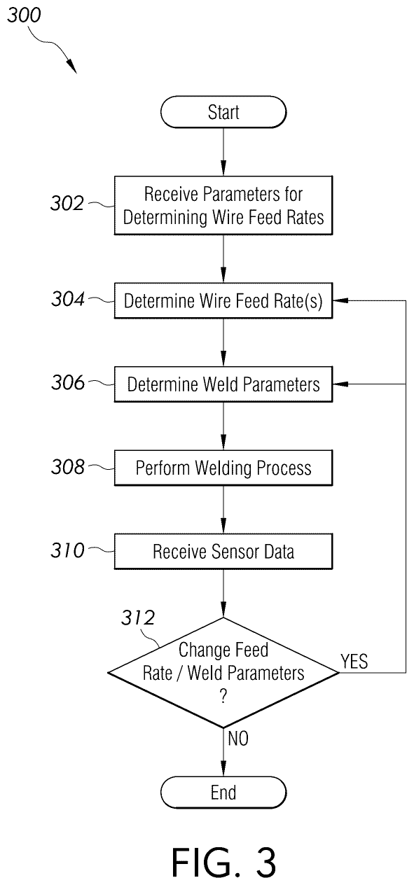

FIG. 3 is a flowchart representative of an example method using individually controlled wire feed rates. At block 302, the system (e.g., any of the ones shown in FIGS. 1A-1D) receives one or more parameters for determining wire feed rates of each of the wire electrodes. As discussed above, the parameters may include, for example, the final amount of each wire in the workpiece, composition at various welding stages, one or more mechanical properties of the work piece to be achieved (which can be used in conjunction with properties of the respective wires to determine a composition of the workpiece), weld pool and joint characteristics, other user input, and the like.

At block 304, the system may determine weld settings (e.g., the initial wire feed rates of each of the wire electrodes or any other example of a weld setting disclosed herein) based on the received parameters, as discussed above. The system may also determine (and/or receive from a user) other weld settings, including, but not limited to, a welding current, torch temperature, or weld pool characteristics. The weld settings may be communicated to the system components (e.g., a welder, wire feeder(s), a torch) as control signals to control the additive welding process.

A welding operation in accordance with the weld settings (e.g., feed rates and other parameters) may be performed at block 308. The welding operation may be monitored using one or more sensors, and the sensor data may be received at block 310.

At block 312 the system may determine whether one or more weld settings (e.g., weld parameters and/or feed rate(s)) need to be modified based on the sensor data (including monitored parameters and/or characteristics). For example, if it is determined based on data received from a tip contact sensor that the feed rate of a wire electrode is too slow or too fast for forming the melt pool (or a stable weld bead), the system may adjust the speed rate(s) or other weld parameters accordingly. The system, therefore, may be a closed look feedback control system.

The process may end when the weld operation is complete.

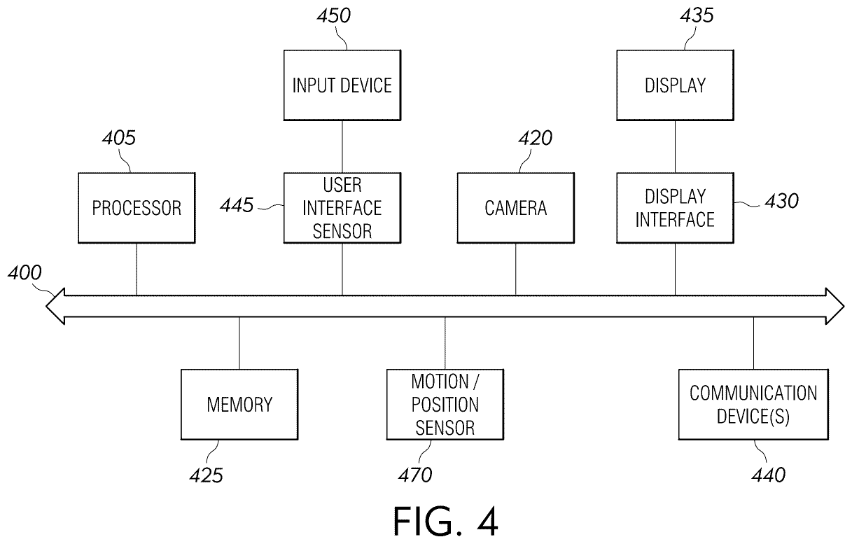

FIG. 4 depicts an example of internal hardware that may be included in any of the electronic components of the system, such as internal processing systems of the AV, external monitoring and reporting systems, or remote servers. An electrical bus 400 serves as an information highway interconnecting the other illustrated components of the hardware. Processor 405 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 425. A memory device may include a single device or a collection of devices across which data and/or instructions are stored. Various embodiments of the invention may include a computer-readable medium containing programming instructions that are configured to cause one or more processors to perform the functions described in the context of the previous figures.

An optional display interface 430 may permit information communicated from the bus 400 to be displayed on a display device 435 in visual, graphic or alphanumeric format, such as a graphical user interface of a welder. An audio interface and audio output (such as a speaker) also may be provided. Communication with external devices may occur using various communication devices 440 such as a wireless antenna, a radio frequency identification (RFID) tag and/or short-range or near-field communication transceiver, each of which may optionally communicatively connect with other components of the device via one or more communication systems. The communication device(s) 440 may be configured to be communicatively connected to a communications network, such as the Internet, a local area network or a cellular telephone data network.

The hardware may also include a user interface sensor 445 that allows for the receipt of data from input devices 450 such as a keyboard or keypad, a joystick, a touchscreen, a touch pad, a remote control, a pointing device and/or microphone. Digital image frames also may be received from a camera 420 that can capture video and/or still images. The system also may receive data from a motion and/or position sensor 470 such as an accelerometer, gyroscope or inertial measurement unit.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

Terminology that is relevant to the disclosure provided above includes:

An “automated device” or “robotic device” refers to an electronic device that includes a processor, programming instructions, and one or more components that based on commands from the processor can perform at least some operations or tasks with minimal or no human intervention. For example, an automated device may perform one or more automatic functions or function sets. Examples of such operations, functions or tasks may include without, limitation, navigation, transportation, driving, delivering, loading, unloading, medical-related processes, construction-related processes, and/or the like.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

An “electronic device” or a “computing device” refers to a device (e.g., a controller) that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

The term “power” is used throughout this specification for convenience, but also includes related measures such as energy, current, voltage, frequency, and enthalpy. For example, controlling “power” may involve controlling voltage, current, energy, frequency, enthalpy, and/or other response characteristics, and/or controlling based on “power” may involve controlling based on voltage, current, energy, frequency, and/or enthalpy.

In this document, when relative terms of order such as “first” and “second” are used to modify a noun, such use is simply intended to distinguish one item from another, and is not intended to require a sequential order unless specifically stated.

In addition, terms of relative position such as “vertical” and “horizontal”, or “front” and “rear”, when used, are intended to be relative to each other and need not be absolute, and only refer to one possible position of the device associated with those terms depending on the device's orientation.

What is claimed is:

1. A welding system for building a workpiece, the system comprising:
a first wire feeder;
a second wire feeder;
a torch configured to configured to receive, via a dual wire feeder connector, a first wire electrode from the first wire feeder and a second wire electrode from the second wire feeder;
a controller comprising logic to:
receive one or more parameters for determining one or more weld settings, wherein the one or more weld settings include a first feed rate of the first wire electrode and a second feed rate of the second wire electrode, and
control the first wire feeder to drive the first wire electrode into the torch at the first feed rate and simultaneously control the second wire feeder to drive the second wire electrode into the torch at the second feed rate.

2. The welding system of claim 1, wherein the system further comprises a welder configured to provide electrical power to the torch, and wherein the controller comprises logic to control, based on one or more control signals, the power source to build the workpiece using the first wire electrode and the second wire electrode.

3. The welding system of claim 1, wherein the first wire electrode comprises a different material from the second wire electrode.

4. The welding system of claim 1, wherein the dual wire feeder connector is configured to receive the first wire electrode and the second wire electrode and direct the first wire electrode and the second wire electrode into the torch.

5. The welding system of claim 4, wherein the dual wire feeder connector comprises a first arm and a second arm configured to receive the first wire electrode and the second wire electrode from the first wire feeder and the second wire feeder respectively.

6. The welding system of claim 5, wherein the dual wire feeder connector comprises a stem portion configured to couple with the torch.

7. The welding system of claim 6, wherein the stem portion comprises a funnel configured to guide the first wire electrode and the second wire electrode into the torch.

8. The welding system of claim 1, wherein the torch is configured to weld the first and second wire electrodes based on one or more control signals, wherein the controller determines the control signals based on the one or more parameters received by the controller.

9. The welding system of claim 8, wherein at least one of the first wire feeder, the second wire feeder, and a first welder are configured to receive the control signals.

10. The welding system of claim 8, wherein the first wire feeder is configured to receive the control signals via the first welder and the second wire feeder is configured to receive the control signals via a second welder.

11. The welding system of claim 8, wherein the first wire feeder is configured to receive the control signals via the first welder.

12. The welding system of claim 1, wherein the one or more parameters comprise at least one of a final composition of the workpiece, a mechanical property of the workpiece, a weld joint configuration, or a quantity of the first wire electrode and the second wire electrode.

13. The welding system of claim 1, wherein the controller comprises logic to adjust at least one of the first feed rate and the second feed rate in real-time based on information received from a sensor.

14. The welding system of claim 1, wherein the system further comprises a user interface operable to receive the one or more parameters.

15. A welding method for building a workpiece, the method comprising:
receiving, via a controller, one or more parameters for determining a first feed rate of a first wire electrode and a second feed rate of a second wire electrode; and
controlling a first wire feeder to drive the first wire electrode into a torch via a dual wire feeder connector at the first feed rate, and simultaneously controlling a second wire feeder to drive the second wire electrode into the torch via the dual wire feeder connector at the second feed rate.

16. The welding method of claim 15, wherein the method further comprises:
controlling, based on one or more control signals, a welder to build the workpiece using the first wire electrode and the second wire electrode, the welder being configured to provide electrical power for establishing a welding arc between a contact tip of the torch and the workpiece.

17. The welding method of claim 15, wherein the one or more parameters comprise at least one of a final composition of the workpiece, a mechanical property of the workpiece, a weld joint configuration, or a quantity of the first wire electrode and the second wire electrode.

18. The welding method of claim 17, wherein the final composition of the workpiece comprises a first composition in a first layer of the workpiece, and a second composition in a second layer of the workpiece.

19. The welding method of claim 15, further comprising adjusting at least one of the first feed rate or the second feed rate in real-time based on information received from a sensor.

20. The welding method of claim 15, the method further comprising:
determining a first wire contribution during a first welding period, and a second wire contribution during a second welding period based on the one or more parameters.
